(19) United States
(12) Patent Application Publication
(10) Pub. No.: US 2013/0085814 A1
(43) Pub. Date: Apr. 4, 2013

(54) Supply Chain Optimization Using a Supply Chain Performance Management Tool

(71) Applicant: COMPETITIVE INSIGHTS LLC, Atlanta, GA (US)

(72) Inventors: Richard Sharpe, Dunwoody, GA (US); Tammy Rowden, Sarasota, FL (US); Lynne Goldsman, Atlanta, GA (US); Beth Urban Hart, Atlanta, GA (US)

(73) Assignee: COMPETITIVE INSIGHTS LLC, Atlanta, GA (US)

(21) Appl. No.: 13/630,759

(22) Filed: Sep. 28, 2012

Related U.S. Application Data
(60) Provisional application No. 61/541,485, filed on Sep. 30, 2011.

(51) Int. Cl. G06Q 10/06

(52) U.S. Cl. 705/7.39

(57) ABSTRACT

A method for providing reports associated with improving supply chain performance may include generating a representation of a supply chain of an organization where the representation is generated responsive to identification of supply chain entities and corresponding flows therebetween. The flows may include transactional layer activities at a stock keeping unit level. The method may further include referencing the representation to define data groupings based on supply chain similarities, establishing baseline data and at least one scenario, and employing the defined data groupings to run a test relative to the at least one scenario, via processing circuitry, to generate performance results relative to the baseline data.

### CROSS REFERENCE TO RELATED APPLICATIONS

This application claims the benefit of U.S. Provisional Application No. 61/541,485, filed Sep. 30, 2011, the contents of each of which are incorporated herein in their entirety.

### TECHNOLOGICAL FIELD

Embodiments of the present invention relate generally to supply chain management solutions and, more particularly, relate to a comprehensive supply chain management solution that enables robust visibility into supply chain processes to, in some cases, further enable improvements in supply chain management and performance monitoring.

### BACKGROUND

For many years, supply chain management has been a focus for organizations such as companies and enterprises with large supply chains. Supply chain management has been focused on managing operational costs and enhancing customer service. To facilitate supply chain management, a number of applications have been developed that assist these organizations in identifying operating improvements aimed at reducing cost and/or improving customer service. These applications have often employed one of three data organization techniques; 1) data aggregation in order to simplify the processes involved and then employed sophisticated mathematical algorithms, 2) detailed transactional data confined to specific aspects of the supply chain operation, or 3) data warehouses that organize data into in compartments that allow for very user specific questions to be addressed. These applications seek to identify costs associated with movement of materials and the provision of services associated with an organization.

However, these data organization techniques are not necessarily representative of the lowest comprehensive level of identification of total costs associated with an individual product that is being handled by the supply chain operation. Moreover, any effort to represent the lowest possible level of identification of materials, which is sometimes referred to as a stock keeping unit (SKU), is typically performed by working backwards from the top levels down to the SKU level. This method of representing SKU data is not necessarily accurate.

Many of the applications currently employed for supply chain management also rely on bulky hardware and/or software deployments or complex data extraction efforts that can heavily weigh down the IT department of some organizations. Even after extraction, the data extracted may still be unreliable or in dispute as to its significance within the organization. Analysis and reports generated may largely be based on a silo approach using data specific to individual portions of the organization, rather than having utility, visibility and accepted applicability across intra-organizational boundaries. Accordingly, it may be desirable to provide improvements in relation to supply chain performance management offerings.

### BRIEF SUMMARY

A method, apparatus, computer program product and system are therefore provided to enable the provision of a supply chain performance management tool that may address some of the problems discussed above. Accordingly, for example, cleansed and/or universally accepted data may be used to provide visibility of supply chain data at the SKU level based on all transactional level information from all parts of the supply chain operation and from all systems used in performing those transactions. In addition, the following examples provide for a way to identify all supply chain related transactional costs and credits at the lowest level of the supply chain transactional layer and determine their impact of specific profits by unique product and customer delivery location. Moreover, some examples may provide a visual representation of supply chain processes based on functional analytics. In some cases, the visual representation may be tied to at least some of the cleansed data so that the cleansed data, or other information derived therefrom, may be accessed directly from links provided in the visual representation. Optimization of processes may be performed, in some cases, based on aggregation of data that relates to similar supply chains. Furthermore, monitoring and reporting services may be provided to enable continued performance management relating so supply chain issues with the potential for SKU level visibility. In some cases, a dashboard may be presented to give executives and other organizational personnel an “at a glance” view of performance management related data.

In an example embodiment, a method for providing reports associated with improving supply chain performance is provided. The method may include generating a representation of a supply chain of an organization where the representation is generated responsive to identification of supply chain entities and corresponding flows therebetween. The flows may include transactional layer activities at a stock keeping unit level. The method may further include referencing the representation to define data groupings based on supply chain similarities, establishing baseline data and at least one scenario, and employing the defined data groupings to run a test relative to the at least one scenario, via processing circuitry, to generate performance results relative to the baseline data.

In another example embodiment, a computer program product for providing reports associated with improving supply chain performance is provided. The computer program product may include at least one computer-readable storage medium having computer-executable program code instructions stored therein. The computer-executable program code instructions may include program code instructions for generating a representation of a supply chain of an organization where the representation is generated responsive to identification of supply chain entities and corresponding flows therebetween. The flows may include transactional layer activities at a stock keeping unit level. The computer-executable program code instructions may further include instructions for referencing the representation to define data groupings based on supply chain similarities, establishing baseline data and at least one scenario, and employing the defined data groupings to run a test relative to the at least one scenario, via processing circuitry, to generate performance results relative to the baseline data.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale and some are offered as a representative view of defined functional aspects of a supply chain operation, as opposed to demonstrating the supply chain operation using latitude and longitude geographical contexts, and wherein:

FIG. 1 is a block diagram illustrating a system for providing a supply chain performance management tool according to an example embodiment of the present invention;

FIG. 2 is a block diagram showing various components that may be included in an apparatus for providing a supply chain performance management tool according to an example embodiment of the present invention;

FIG. 3 illustrates a block diagram of operations performed in association with operation of a profiling module according to an example embodiment of the present invention;

FIG. 4 illustrates a visual representation of all of the facilities involved with a supply chain of an organization according to an example embodiment of the present invention;

FIG. 5 illustrates flows between various ones of the entities of the supply chain of FIG. 4 according to an example embodiment of the present invention;

FIG. 6 illustrates a representation of the inbound flows to manufacturing centers of FIG. 5 according to an example embodiment of the present invention;

FIG. 7 illustrates a representation of the inbound flows to distribution centers and sales & service centers of FIG. 5 according to an example embodiment of the present invention;

FIG. 8 illustrates a representation of inter-facility flows between manufacturing centers and distribution centers of FIG. 5 according to an example embodiment of the present invention;

FIG. 9 illustrates a representation of inter-facility flows between distribution centers and sales & service centers within a region of the supply chain of FIG. 5 according to an example embodiment of the present invention;

FIG. 10 illustrates a representation of inter-facility flows between regions are show according to an example embodiment of the present invention;

FIG. 11 illustrates a representation of all inter-facility flows of the supply chain of FIG. 5 according to an example embodiment of the present invention;

FIG. 12 illustrates outbound flows from manufacturing and distribution centers of the supply chain of FIG. 5 according to an example embodiment of the present invention;

FIG. 13 illustrates outbound flows from distribution centers and sales & service centers to customers of the supply chain of FIG. 5 according to an example embodiment of the present invention;

FIG. 14 illustrates a block diagram of some of the operations that may be associated with optimization according to an example embodiment of the present invention;

FIG. 15 illustrates a block diagram of some of the operations that may be associated with monitoring according to an example embodiment;

FIG. 16 illustrates an example screenshot of a supply chain performance management dashboard that may be presented according to an example embodiment;

FIG. 17 illustrates an example drill down report for net landed cost to serve according to an example embodiment;

FIG. 18, which includes FIGS. 18A, 18B, 18C and 18D, illustrates various levels of drill down capability all the way to the SKU level according to an example embodiment;

FIG. 19 illustrates a report page presented responsive to selection of the top customer chart from the dashboard of FIG. 16 according to an example embodiment;

FIG. 20 illustrates a report page showing inventory related charts according to an example embodiment;

FIG. 21 illustrates reports associated with outbound transportation mode according to an example embodiment;

FIG. 22 illustrates a report associated with SKU profiling based on profit contribution according to an example embodiment; and

FIG. 23 is a block diagram according to an exemplary method for providing a supply chain performance management tool according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, some embodiments of the present invention are aimed at providing a mechanism by which to improve supply chain performance management. In this regard, for example, some embodiments may provide a network structure by which services associated with supply chain management may be provided to facilitate the provision of robust capabilities for supply chain management. Within the network structure, some embodiments may also provide a centrally hosted, software as a service (SaaS) delivery model. Users may therefore be enabled to access supply chain management functionality over a network (e.g., the Internet) via a web browser. Moreover, in some cases, the access provided to users may be secure (e.g., employing SAS 70, type II security).

Example embodiments may enable analyzing a supply chain using descriptive tools (e.g., tools for describing historical information or situations), predictive tools (e.g., tools for predicting an outcome in relation to cost, profit and risk), and prescriptive tools (e.g., tools for identifying or suggesting a new way of doing something in order to achieve a better outcome. As used herein, any reference to optimization should be understood as employment of a prescriptive tool. Thus, optimizing and prescribing should be considered to be substantially identical in meaning within the context of the present application.

In an example embodiment, data used for analysis and report generation may be extracted in its native format in order to mitigate or eliminate demands upon organizational information and technology staff. Moreover, the data may be extracted at the transactional level from any number of supply chain and other types of operating systems in the native format that those systems store and process that transactional data and is subsequently cleansed, so that the data is representative of SKU level information that is agreed upon within the organization as to its accuracy and applicability. In some embodiments, data at the SKU level may be exposed to users based on their respective permission levels and using tools for report generation. Reports may be generated or accessed using a dashboard application, or other delivery component. End to end supply chain related data may therefore be exposed to organizations at the SKU level. Thus, embodiments of the present invention may provide a relatively easy way by which executives and other organizational personnel may obtain an “at a glance” view of supply chain related data that is universally accepted within their organization. Moreover, using functionality associated with the dashboard, information may be consumed at a number of levels from the overall global supply chain to a specific customer delivery location to all the way down to the SKU level using drill down functions associated with specific reports accessible via the dashboard.

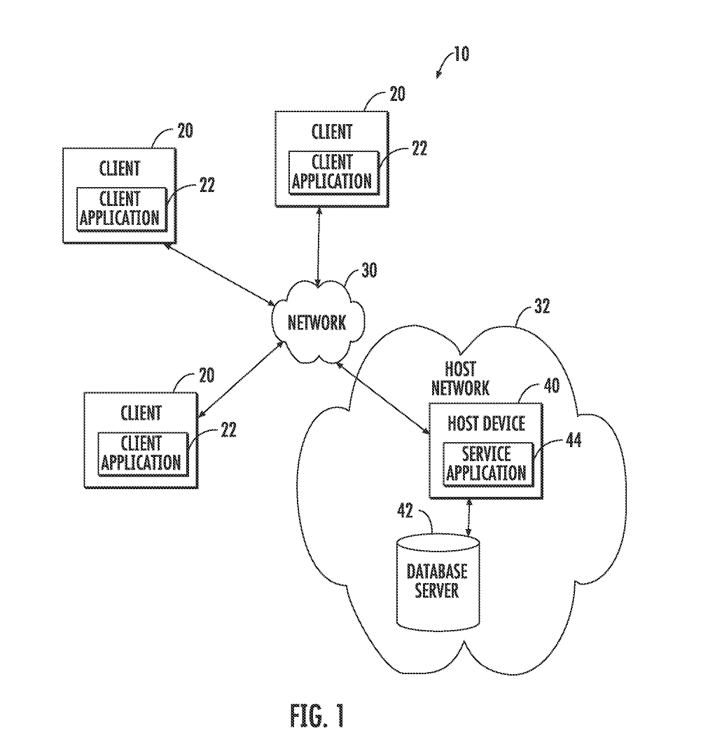

An exemplary embodiment of the invention will now be described in reference to FIG. 1, which illustrates an exemplary system in which an example embodiment of the present invention may be employed. As shown in FIG. 1, a system 10 according to an exemplary embodiment may include one or more clients 20 that may, in some cases, be associated with different corporations, or different entities within an enterprise or large corporation. As such, each of the clients 20 may be related to each other (e.g., as different portions of a single enterprise's supply chain). For example, one client 20 may be associated with a purchase management system, another client 20 may be associated with an enterprise resource planning (ERP) system, another client 20 may be associated with warehouse management system (WMS), still other clients could be provided associated with, for example, point of sale (POS) systems, transportation management systems (TMS), production management systems and/or the like, within a single enterprise. However, it should also be appreciated that in some embodiments, multiple different corporations or enterprises may be served by the system 10 of FIG. 1. Thus, the set of clients 20 shown in FIG. 1 could be repeated for another or multiple different organizations. Furthermore, in some cases, an entire enterprise or organization could be serviced by interface with only one client 20.

Each client 20 may be, for example, a computer (e.g., a personal computer, laptop computer, network access terminal, or the like) or may be another form of computing device (e.g., a personal digital assistant (PDA), cellular phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an exemplary embodiment, one or more of the clients 20 may include a client application 22 configured to enable operation in accordance with an exemplary embodiment of the present invention. In this regard, for example, the client application 22 may include software for enabling a respective one of the clients 20 to communicate with the network 30 for the provision of and receipt of information associated with providing supply chain performance management tools in accordance with example embodiments as described herein. As such, for example, the client application 22 may include corresponding executable instructions for configuring the client 20 to provide corresponding functionalities for the provision of and receipt of information associated with providing supply chain performance management tools in accordance with example embodiments as described herein. Moreover, in an exemplary embodiment, the client application 22 may be embodied as a web browser enabled to access information and services via a secure website accessible via the network 30.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols. In an example embodiment, the network 30 is the Internet.

In an exemplary embodiment, one of the devices to which the clients 20 may be coupled via the network 30 may include one or more host devices (e.g., host device 40). The host device 40 may be a computer or network server hosting SaaS functionality as described herein. In some cases, the host device 40 may be capable of communication with one or more database servers 42 that may provide robust and secure storage of data. In an example embodiment, the host device 40 and the database server 42 may form respective elements of a host network 32, which may include multiple servers, databases, computers and/or access terminals via which functions of the host device 40 may be accessed. Although the host device 40 and the database server 42 are depicted as separate devices, this does not necessarily imply that they are embodied on separate servers or devices. As such, for example, a single server, computer or other device may include both entities and the database server 42 could merely be represented by a database or group of databases physically located on the same server as the host device 40. The host device 40 and the database server 42 may each include hardware and/or software for configuring the host device 40 and the database server 42, respectively, to perform various functions. As such, for example, the host device 40 may include processing logic and memory enabling the host device 40 to access and/or execute stored computer readable instructions for performing various functions. In an exemplary embodiment, one function that may be provided by the host device 40 may be the provision of supply chain performance management tools to the clients 20. In this regard, for example, the host device 40 may include a service application 44 comprising stored instructions for processing data and/or accessing information and providing such information to the client applications 22 based on requests provided at each respective client 20.

Additionally or alternatively, the host device 40 may be configured to enable the clients 20 to provide information to the host device 40, for use by the host device 40 in producing, maintaining and/or supplying profiling services, optimization services and/or monitoring services associated with performance management of supply chain issues as described herein. In this regard, for example, the host device 40 (or servers) may include particular applications related to profiling the organization's supply chain. This profiling may include, for example, enabling visual representations of the supply chain of an organization (e.g., an enterprise or corporation) to be provided using functional analytics. The host device 40 may then further enable data to be received from one or more of the clients 20 at the transactional level and in whatever native format the data may initially exist. The transactional level data may then be cleansed and analyzed so that, for example, it may be tied back to the visual representation by mapping the data to the functional analytics. After validation of the cleansed data as described in greater detail below, logic used for processing the data may be stored for future use in connection with processing data from the organization.

The visual representation may illustrate a functional representation of the flows within the supply chain of the organization. After the accuracy of the representation is confirmed, the visual representation may assist in exposing SKU level visibility of supply chain costs, risks, and other performance characteristics. Personnel associated with the organization may study the supply chain flows and the corresponding data associated therewith, some of which may be further processed to generate reports as described in greater detail below, in order to make determinations regarding cost savings policies or other actions to improve supply chain performance.

In some embodiments, the host device 40 may further provide optimization services. However, unlike many optimization services that simply aggregate data on a product grouping basis such as the way the products are marketed or sold, the host device 40 of an example embodiment may enable data aggregation prior to optimization where the aggregation is performed on the basis of supply chain similarities. Moreover, the optimization may thereafter be granularized to provide improved granularity to the information provided by the optimization service.

In some embodiments, monitoring and reporting services may also be provided by the host device 40 via the service application 44. In this regard, for example, various different performance management reports may be generated and monitoring may be conducted at a desired interval or frequency. The reports may be highly customized and may be layered to enable users from multiple organizational functions such as sales, finance, marketing, operations and supply chain, to drill down to various deeper levels including all the way to the SKU or customer delivery location level. In some cases, users at multiple levels or having multiple different organizational functions may be enabled to access the very detailed information for any part of the organization. However, in other examples, access to information may be granted on the basis of permissions granted to specific users for varying different levels of access. Thus, for example, some users may be enabled to access all information, or at least some cross functional information, while other users may only be enabled to access information associated with their particular function. Similarly, in some cases, users may be granted the ability to manipulate data and/or reports based on a user classification. For example, some users may be classified as end users only, so that they can only access existing reports and cannot modify the data. However, other users may have the ability to define rules for data processing and/or report generation and monitoring activities. In some cases, analysis may be performed with respect to monitored data in order to enable alerts to be produced.

In an exemplary embodiment, the host device 40 may include or have access to memory (e.g., internal memory or the database server 42) for storing instructions or applications for the performance of various functions and a corresponding processor for executing stored instructions or applications. In an exemplary embodiment, the host device 40 may include the service application 44 configured to operate in accordance with an exemplary embodiment of the present invention. In this regard, for example, the service application 44 may include software for enabling the host device 40 to communicate with the network 30 and/or the clients 20 for the provision and/or receipt of information associated with providing the supply chain performance management tools. As such, for example, the client application 22 may include corresponding executable instructions for configuring the client 20 to request information (e.g., from the service application 44) regarding one or more reports to enable the presentation of the reports at the client 20. The service application 44 may therefore be configured to provide corresponding functionalities for the provision and/or receipt of information associated with providing the supply chain performance management tools as described in greater detail below. As such, the client 20 may be a “thin client” that accesses software as a service that is hosted at the host device 40 employing functionality provided by the service application 44. In an example embodiment, the service application 44 may be capable of providing services associated with the CL.RADAaR system described in pages 1-75 of the attached Appendix A.

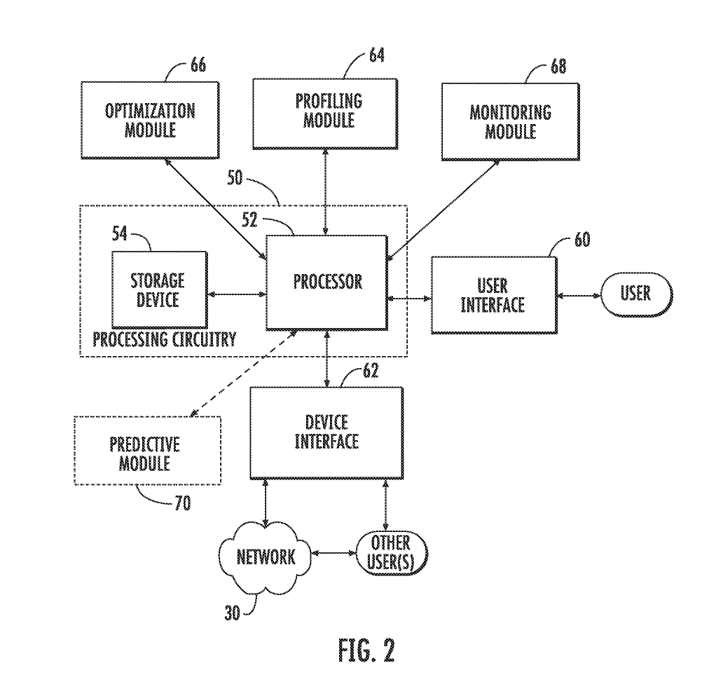

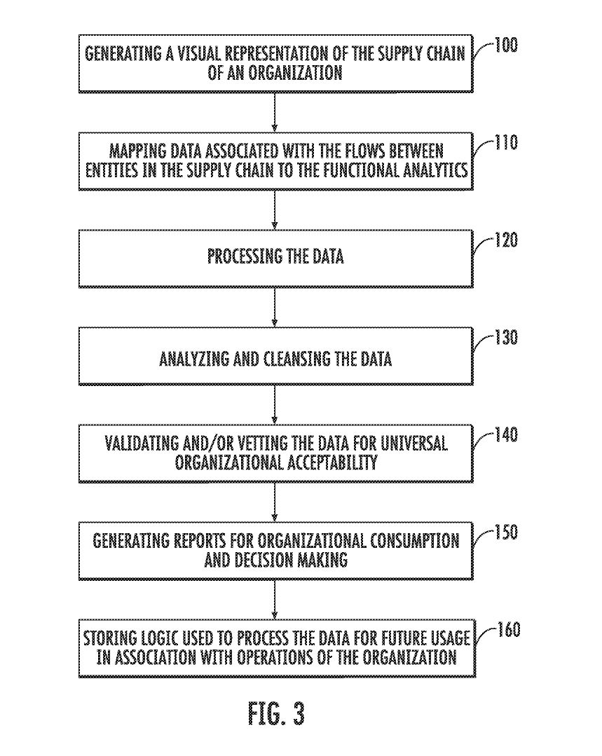

An exemplary embodiment of the invention will now be described with reference to FIG. 2. FIG. 2 shows certain elements of an apparatus for providing supply chain performance management tools according to an exemplary embodiment. The apparatus of FIG. 2 may be employed, for example, on the host device 40 of FIG. 1, or a variety of other devices (such as, for example, a network device, server, proxy, or the like). Alternatively, embodiments may be employed on a combination of devices. Accordingly, some embodiments of the present invention may be embodied wholly at a single device (e.g., the host device 40) or by a combination of peer devices or devices in a client/server relationship. Furthermore, it should be noted that the devices or elements described below may not be mandatory and thus some may be omitted in certain embodiments. Moreover, other embodiments, may add additional devices or functions to those shown in FIG. 2.

Referring now to FIG. 2, an apparatus for providing supply chain performance management tools is provided. The apparatus may include or otherwise be in communication with processing circuitry 50 that is configured to perform data processing, application execution and other processing and management services according to an exemplary embodiment of the present invention. The processing circuitry 50 may be configured to perform data processing, control function execution and/or other processing and management services according to an example embodiment of the present invention. In some embodiments, the processing circuitry 50 may be embodied as a chip or chip set. In other words, the processing circuitry 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 50 may therefore, in some cases, be configured to implement an embodiment of the present invention on a single chip or as a single “system on a chip.” As such, in some cases, a chip or chipset may constitute means for performing one or more operations for providing the functionalities described herein.

In one embodiment, the processing circuitry 50 may include a processor 52 and a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal within the host network 32) that may be in communication with the processing circuitry 50 via the device interface 62 and/or a network (e.g., host network 32).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., service application 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control a profiling module 64, an optimization module 66 and a monitoring module 68. The profiling module 64, the optimization module 66 and the monitoring module 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the profiling module 64, the optimization module 66 and the monitoring module 68, respectively, as described below. As such, in some embodiments, the processor 52 (or the processing circuitry 50) may be said to cause each of the operations described in connection with the profiling module 64, the optimization module 66 and the monitoring module 68, respectively, by directing the profiling module 64, the optimization module 66 and the monitoring module 68 to undertake the corresponding functionalities responsive to execution of instructions or algorithms configuring the processor 52 (or processing circuitry 50) accordingly.

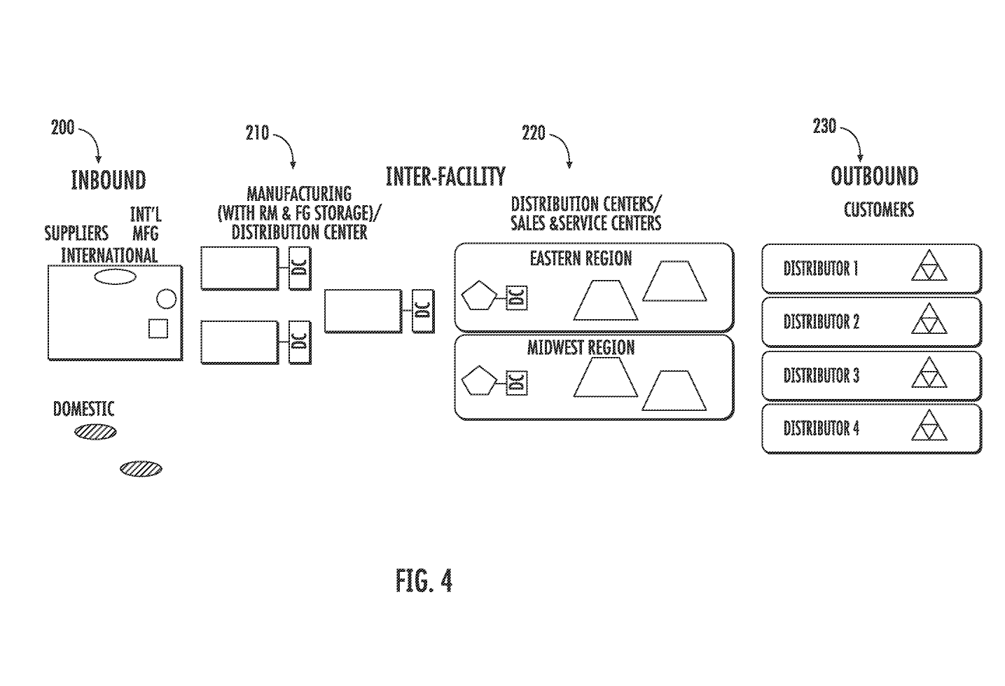

The profiling module 64 may be configured to provide profiling services relative to the supply chain of an organization being serviced by the system 10. FIG. 3 illustrates a block diagram of operations performed in association with operation of the profiling module 64. As shown in FIG. 3, the profiling module 64 may be configured to generate a visual representation of the supply chain of an organization at operation 100. The profiling module 64 may be further configured to map data associated with the flows between entities in the supply chain to the functional analytics at operation 110. At operation 120, the profiling module 64 may be configured to process the data. Processed data may then be analyzed and cleansed at operation 130. The processed data may be validated and/or vetted for acceptability at operation 140. After acceptance of the processed data, reports may be generated for organizational consumption and decision making at operation 150. At operation 160, all logic used to process the data may be stored for future usage in association with operations of the organization.

In an example embodiment, the generation of the visual representation at operation 100 may be accomplished responsive to receipt of input from organizational personnel that is descriptive of the supply chain. In this regard, for example, an analyst (or analysts) may interview organizational personnel in relation to the inbound supply chain flows, inter-facility supply chain flows, outbound supply chain flows, reverse product supply chain flows, product storage activities, product manufacturing activities, purchasing and sourcing activities, product destruction activities, customer product sales activities and any associated credits or debits to sales transactions, product and customer related profit transactions and activities related to that operation but which the information is provided by a third party, inventory activity levels and additional cost considerations associated with various inventory procedures and policies that are associated with the organization.

Inbound supply chain flows may include the acquisition of raw or processed materials that form the initial components that enter the organization's supply chain. These materials may be referred to as SKUs, as indicated above. The inbound supply chain flows may initially be reported and then entered into the service application 44 for operation by the profiling module 64 to generate corresponding flows of inbound materials from ports, receiving terminals or other inbound entry points to the facilities (e.g., manufacturing, sales & service or distribution centers) of the organization. Inter-facility flows may represent the flow of SKUs or processed materials between different manufacturing, sales & service, distribution centers or other customer or third party operated facilities. Outbound supply chain flows represent the movement of finished goods to customers. Reverse product supply chain flows may also be represented in some embodiments.

Based on information received from the organization, a visual representation of all of the facilities involved with the supply chain of the organization may be generated as illustrated in FIG. 4. In this regard, the analyst may inquire as to each international inbound supplier and each domestic supplier and the locations of the production facilities, ports or entry points via which the inbound suppliers provide their materials to the organization. A listing of the inter-facility manufacturing facilities, storage facilities, sales centers, service centers, and distribution centers of the organization may also be obtained along with their corresponding relationships and/or locations. A listing of customers and their corresponding facility locations may also be obtained as a representative listing of outbound facilities associated with the supply chain of the organization.

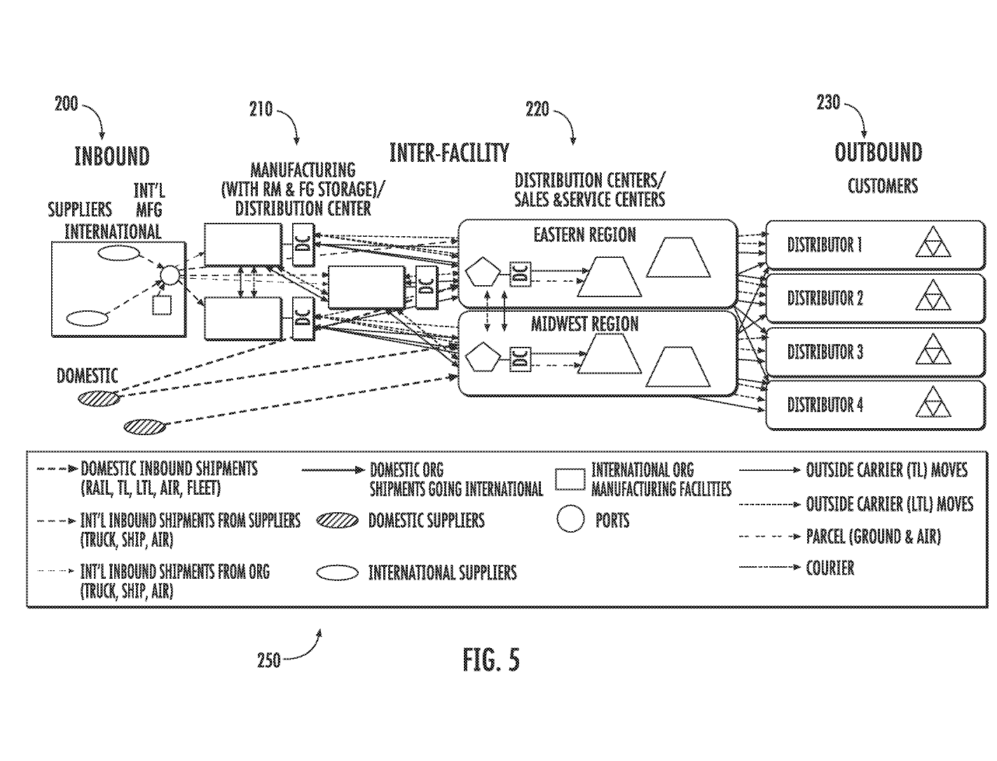

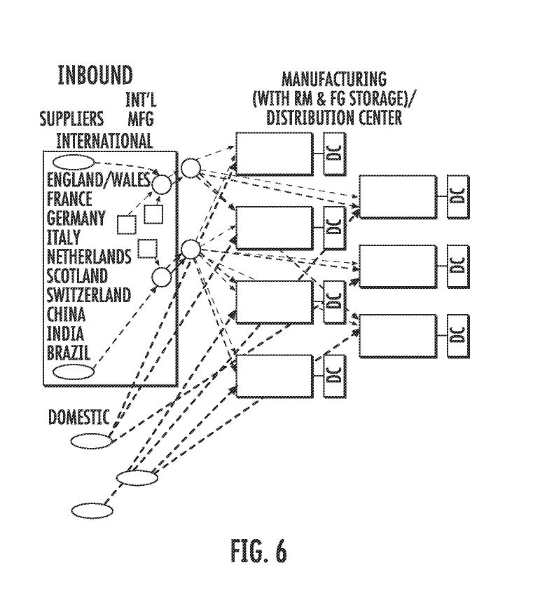

The listings of entities involved in the inbound, inter-facility and outbound portions of the supply chain may be used to generate a visual representation of all of the facilities associated with the supply chain, organized according to their respective positions in the chain as indicated in FIG. 4. In an example embodiment, the profiling module 64 may include functionality enabling listings of each facility or entity and its corresponding function (e.g., international supplier, sales center, customer facility, port, etc.) to be provided via a web page or control console. The data entered may then be used to facilitate generation of the visual representation of each entity to be generated based on the characteristics of each respective entity using a rule set identifying which visual representation and positioning to employ with respect to each listing provided for corresponding given characteristics. An identity of the corresponding entity may then be represented graphically in association with its corresponding facility type (e.g., domestic supplier, regional distribution center, etc.), organized according to its respective position in the supply chain (inbound supply chain entities 200, inter-facility supply chain entities (e.g., manufacturing entities 210 and distribution/sales & service centers 220) or outbound supply chain entities 230) as shown in FIG. 4. In some embodiments, information indicative of the location of the corresponding entity may also be provided. Other identifying information (e.g., facility title or name) may also be provided. After the entities associated with the supply chain have been identified and represented, the flows between various ones of the entities may be represented. In an example embodiment, the analyst may again use information provided by the organization that is descriptive of the flows, to generate a visual representation or flow link 240 indicating the existence of each of the flows (e.g., using arrows) as shown in FIG. 5. In some embodiments, the flow links 240 may be unique to each respective different type of flow. For example, domestic inbound shipments (e.g., by air, rail, truck (fully or partially loaded), or fleet) may be represented differently than international inbound shipments (e.g., by truck air or ship). Carrier moves by fully loaded truck may be illustrated differently than moves associated with partially loaded trucks. Parcel (e.g., ground and air) shipments may also be illustrated differently than courier shipments. Color coding, line characteristics or any other suitable distinction may be used to illustrate different characteristics of the flow links. In some cases, a legend 250 may be provided (as shown in FIG. 5) to indicate the different characteristics of each respective item shown. The flow links 240 may, in some cases, be entered as a list of links into one or more web pages or control consoles. The data entered may then be used to facilitate generation of the visual representation of each flow link 240 to be generated based on the characteristics of each respective flow link 240 using a rule set identifying which visual representation to employ with respect to each flow between respective entities given the characteristics of the respective flows as defined when the links are entered. In some cases, the web pages or control consoles for entry may be associated with specific types of flows. For example, one page may be used to enter all flows associated with domestic inbound shipments, and another page may be used to enter all flows associated with courier moves.

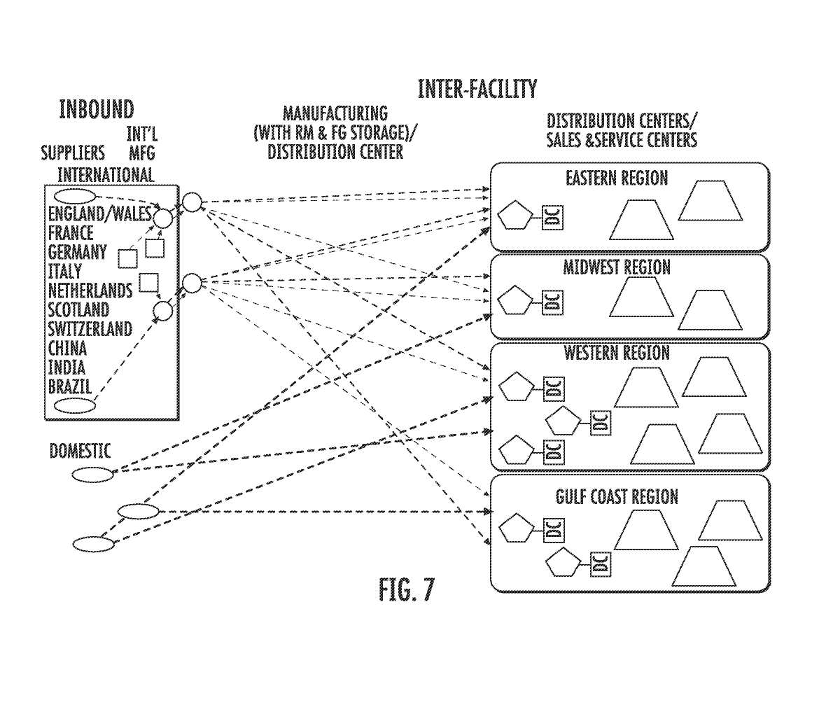

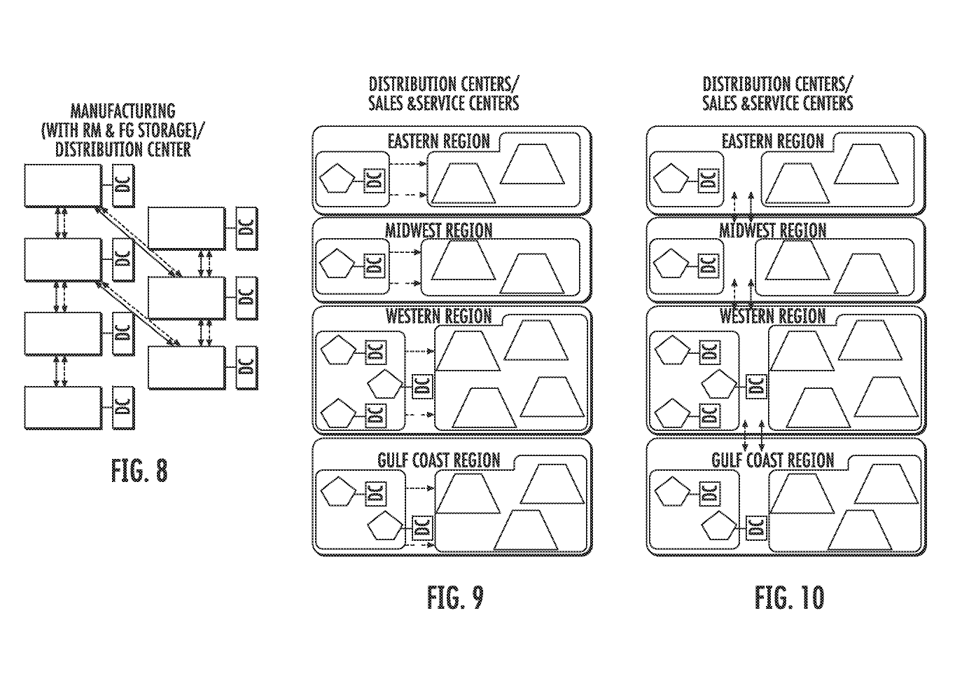

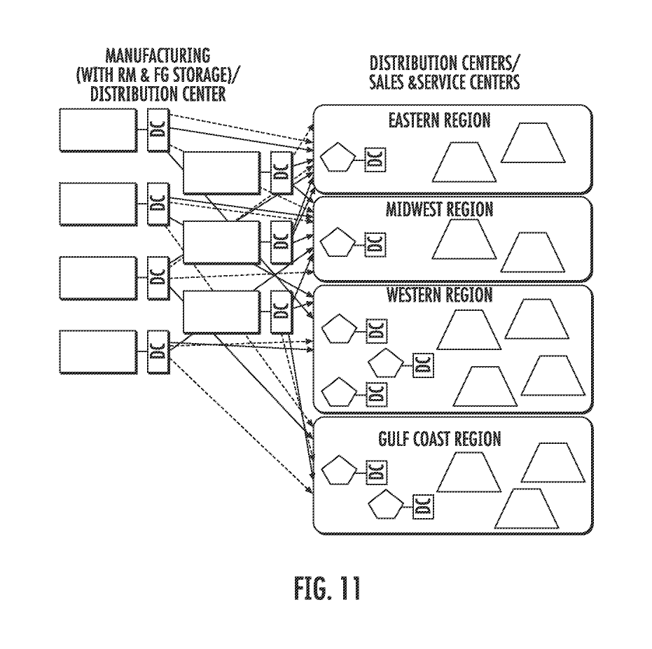

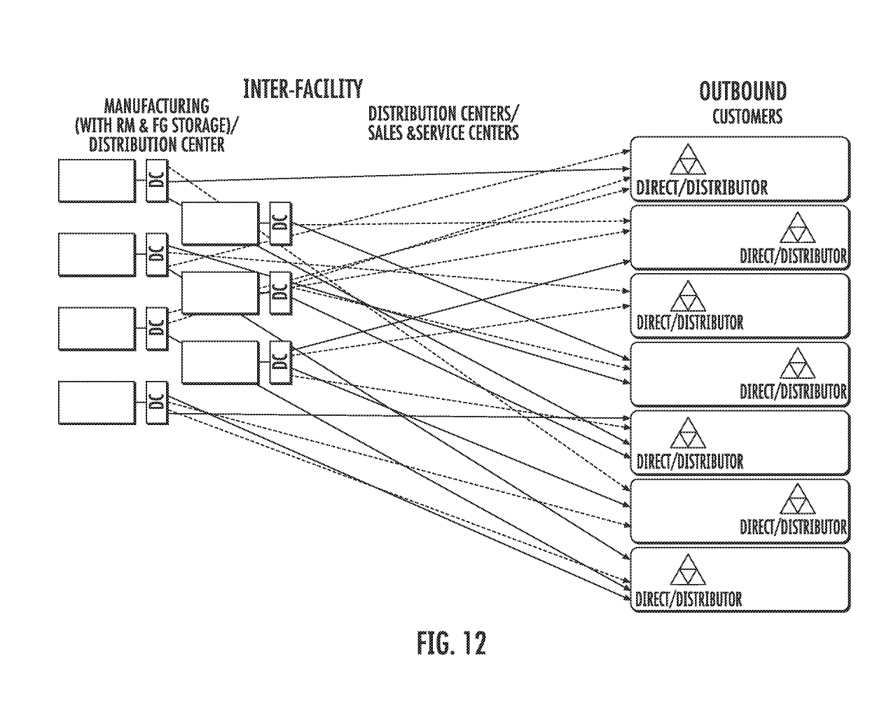

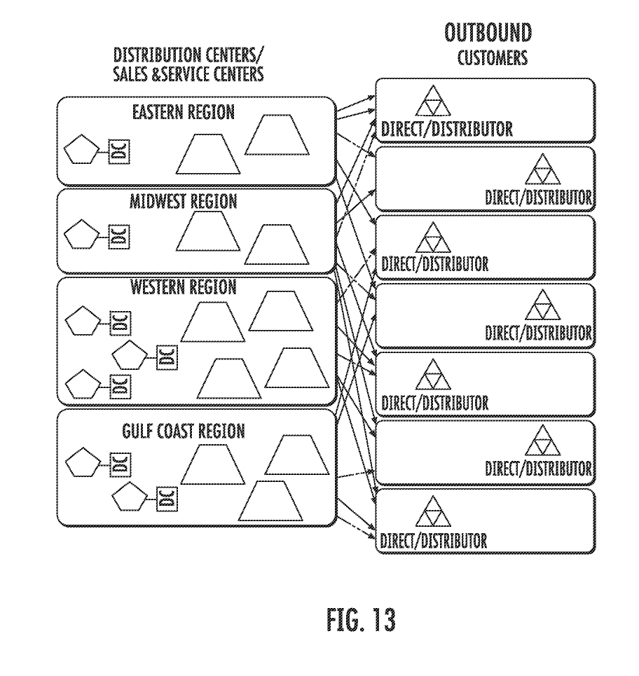

In an example embodiment, the visual representation of the supply chain shown in FIG. 5 may be illustrative of a functional representation of an end to end view of the flows of materials between entities involved in the supply chain of the organization and the corresponding costs, activities, risks and profits associated with the entities and/or other actors/actions involved in the operation of the supply chain. In some cases, the analyst may present the visual representation to organization personnel to confirm that the flows and entities are accurately represented. In some embodiments, the visual representation may be presented as a document or presentation item that is not interactive. However, in other embodiments, the visual representation may be provided in a manner that further enables interaction therewith to filter the presentation according to user desires. For example, in some cases, the operator may be enabled to filter the presentation to show only certain flow links and corresponding entities. Furthermore, in some cases, flows, entities or any other objects in the visual representation may be selected to link to an information window or pop up screen that provides detailed visibility of very specific costs, volumes, risks and profits associated with an SKU. In some cases, risk associated with particular channels or entities may be reported in connection with each corresponding channel or entity as well. Furthermore, for any data presented (e.g., costs, volumes, risks, profits, etc.) thresholds may be assigned above which some form of altering mechanism (e.g., changing the color, font, etc.) may be initiated in connection with the data when the data is retrieved. Filtration of flow links and/or entities, as mentioned above, may be provided along predefined or user selected boundaries. In this regard, FIG. 6 illustrates an example in which inbound flows to manufacturing centers are shown. FIG. 7 illustrates an example in which inbound flows to distribution centers and sales & service centers are shown. FIG. 8 illustrates an example in which inter-facility flows between manufacturing centers and distribution centers are shown. FIG. 9 illustrates an example in which inter-facility flows between distribution centers and sales & service centers within a region are shown and FIG. 10 illustrates an example in which inter-facility flows between regions are shown. FIG. 11 illustrates an example in which all inter-facility flows are shown. Meanwhile, FIG. 12 illustrates outbound flows from manufacturing and distribution centers to and FIG. 13 illustrates outbound flows from distribution centers and sales & service centers to customers.

In some embodiments, organizational personnel may be enabled to cycle through any or all of the views presented in FIGS. 4-13 using drop down menus, forward/back buttons or any other navigational structure. As such, FIGS. 4-13 may represent functional analytics used to generate visual representations of the supply chain of the organization in an end to end fashion that can be further investigated at more granular levels according to the desires of organizational personnel to confirm the accuracy of the flows represented.

After generation of the visual representation of the supply chain of the organization at operation 100 using the functional analytics described above, the profiling module 64 may be configured to map data associated with the flows between entities in the supply chain to the functional analytics at operation 110. In other words, data associated with the flow links 240 may be associated (e.g., via the mapping) with each respective one of the flow links 240. In an example embodiment, the data used may be extracted in its native format. As such, there may be no requirement for organizational personnel to reformat or collect data in a particular format. Instead, for example, organizational personnel (e.g., IT personnel) may forward data indicative of the flow links 240 to a particular site or location (e.g., using FTP (file transfer protocol)) associated with the host device 40 and/or the service application 44. In some cases, multiple facilities or entities within the organization may report data to the same site or location. Thus, collection of data may be relatively transparent and of low impact to the organization. At the host network 32 side, the data forwarded by the organization may be stored in a database or location (e.g., the database server 42) that is associated exclusively with the organization.

In an example embodiment, the data provided to the host device 40 may be transactional layer data. As such, the data may represent the transactions that bring each SKU into the supply chain and therefore provide SKU level supply chain data that is determined from the bottom up, rather than being extrapolated or allocated from the top down. The mapping of the transactional layer data to the functional analytics allows end to end supply chain data to be made visible via the visual representation in some embodiments. For example, in some cases, the flow links 240 may be selected by a user to retrieve specific data associated with the corresponding flow. The flow link 240 may indicate information about the corresponding data at the SKU level, or enable the user to drill down to the SKU level. As such, the visual representation may be tied directly to the data in a user accessible manner.

As indicated above, the profiling module 64 may be configured to process the data at operation 120. The processing may include receiving the data and using processing tools or modules (e.g., a SQL server) to convert the raw data received in its native format into a format associated with processed data. In an example embodiment, an analyst may initially review the raw data (e.g., data in its native format) and identify rules for conversion of the raw data to processed data. In some embodiments, the raw data may include information related to transactional level documents or records that may include references to materials and/or the like within the context of the parlance of the company or business unit or entity of the organization with which the transactions are involved.

In an example embodiment, the processing of the data may also include linking of the data via data linkage keys. The data linkage keys may be terms that can be used to associate or link data within its native format provided within the context of one transaction, to corresponding data within its (perhaps different) native format that is provided within the context of another transaction. The data linkage keys may include, for example, SKU numbers, purchase order numbers, bills of lading, inventory identifiers, and/or the like. In some cases, by linking data across the organization, SKUs that were thought to be active by certain functional groups within an organization may actually be resolved to not be an active product or item. The linkage of data may be performed via a rule based system where the rules are unique to each respective organization. In this regard, for example, after appreciating the correlations between the raw data in its native format and the corresponding processed data terminology for respective items, a rule set may be developed and programmed into the host device 40 for conversion of the raw data (in its native format) into processed data useable by the host device 40 and the service application 44 for report generation, monitoring and/or optimization. Since raw data formats and parlance may be unique to each organization, the rule set may also be unique to the organization. Thus, the rule set may be stored to the database server 42 (or a portion thereof) that is dedicated to the organization.

The analysis of processed data may be accomplished along with cleansing at operation 130. In this regard, for example, processed data that is sewn or linked together (e.g., via the data linkage keys) may be cleansed using algorithms employed by the profiling module 64 to parse data to identify missing data (e.g., no costs being listed for specific flows) or outlier data. In this regard, for example, statistical analysis may be used to identify where certain costs appear to be higher or lower than expected or than that which is typical for corresponding transactions of the same type. In many instances, it may be discovered that some entities account for certain transactions differently via organizational feedback. When such instances are discovered, rules for converting data associated with those situations may be added to the rule set to provide consistent processed data relating to these instances. After the processed data has been analyzed to identify missing or outlying data and such deficiencies are corrected, the processed data may further be considered to be cleansed.

Processed data that is cleansed and sewn or linked appropriately may then be validated and/or vetted for acceptability at operation 140 by a cross functional team of organizational personnel to generate enhanced data done with special data organization and reporting techniques to facilitate this process. The cross functional team (which may be defined prior to operation 100 or at any other point in the processing) may include members of the organization across different disciplines or entity boundaries. For example, the cross functional team may include sales personnel, manufacturing personnel, supply chain personnel, customer service personnel, and/or the like. The cross functional team may review the data and the visual representation to confirm the accuracy of all of the flows and the data associated therewith. Any discrepancies may be resolved and modifications to the rule sets may be made accordingly in order to ensure that the rule sets accurately generate enhanced data that is universally accepted within the organization as accurately reflecting the end to end view of the supply chain to the SKU level.

After acceptance of the processed data, reports may be generated for organizational consumption and decision making at operation 150. In this regard, consensus may be reached in relation to the data associated with the functional analytics and, the data may be studied in order to identify operational opportunities that can be exploited to increase specific SKU or customer profitability, improve productivity, reduce costs, and/or improve customer service. This allows for all functions of the operation (sales, finance, marketing, operations, supply chain, etc.) to be using one common source of information to generate detailed operational visibility to specific parts of the operation's performance. At operation 160, all logic used to process the data may be stored for future usage in association with operations of the organization. In other words, the visual representation and all of the enhanced data may be stored along with the rule sets employed in order to generate the mapping of the functional analytics to the native data and cleanse the data.

In an example embodiment, operations 100 to 160 may be undertaking in connection with a process of profiling the organization. As indicated above, many different organizations may be profiled using example embodiments, and data (including native formats associated therewith) may be unique for each organization. Thus, the profiling of any particular organization may be accomplished such that the database of enhanced data for the particular organization is segregated for the corresponding particular organization. As such, all of the particular organization's data is securely and separately stored (e.g., using SAS 70, type II compliant security) with permissions being required to be given to govern access to the data. In an example embodiment, the service application 44 may provide certain functionality (e.g., general report generation functionality, data or report retrieval functionality, optimization functionality, monitoring functionality and/or the like) that is universally available to all users. However, the functionality may only be performed with respect to data that is accessible based on the permissions granted to each user. Each user may then be granted different access credentials that may enable the users to perform permitted functions for their respective permission levels with respect to the organization's data.

Accordingly, for example, when the client application 22 of any particular client 20 is employed to access the service application 44, the client 20 may access a secure web site. The secure website may be specifically associated with the organization, or the user may select the organization with which the user is associated in order to complete the access procedure. In some cases, the user may be required to enter credentials (e.g., a username and password) to authenticate the user. In some embodiments, the username may be associated with a particular organization or entity within an organization. The username may therefore be associated with a corresponding permission level that defines the level of access for which the user is granted access and/or the data set to which access is granted. The permission level may also, in some cases, define which functionalities are made available to the user including which reports may be generated or retrieved. Although user may only have access to selected data, using one common source for all cross-functional performance reporting eliminates the problem of different parts of the organization having a variety of multiple views of data, each generated from possibly different data sources and operating systems and with different calculation logic defined by each user.

The operations of the profiling module 64 may be conducted with user input from an analyst (e.g., for rule set definition, identifying correlation of data using data linkage keys, providing inputs for defining entities and flows in the functional analytics, inputting organizational feedback for modifying rule sets, cleansing data, and validating data, and/or the like) or directly from organizational personnel (e.g., to navigate the visual representation, select data from links in the visual representation, view reports, and/or the like). As such, the profiling module 64 may operate to give a technical basis upon which information is provided to organizational personnel and to respond to inputs requesting analysis, reports and processing as described above.

After completing the process of profiling using the profiling module 64 as defined in FIG. 3, the organization may decide to proceed to other levels of service including, for example, optimization and/or performance monitoring. In some cases, profiling may be performed without following on to optimization or performance monitoring. However, in other cases, optimization and performance monitoring may be performed temporally independently of each other (i.e., at different times) or coincident in time. Alternatively, one or the other of optimization and performance monitoring may be performed, but not both. In still other examples, the organization may elect not to proceed to either optimization or performance monitoring.

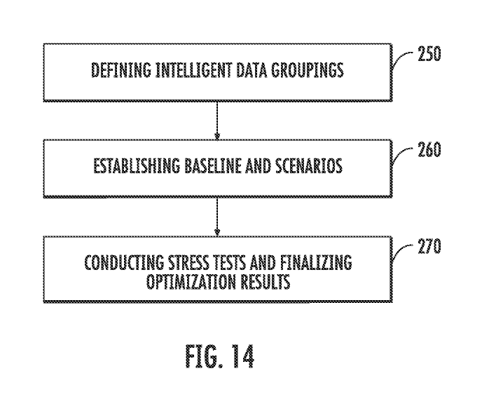

FIG. 14 illustrates a block diagram of some of the operations that may be associated with optimization according to an example embodiment. In this regard, the optimization module 66 may perform some of all of the operations illustrated in connection with the example operations shown in FIG. 14. As shown in FIG. 14, the optimization module 66 may be configured to perform a definition of intelligent data groupings at operation 250. Optimization may often be performed by running optimization algorithms or software applications on aggregated data (not transactional level data) given that the computational load for optimization can be very heavy. The aggregation of data is typically performed based on product sales grouping or product marketing groupings. However, this type of grouping is artificial in relation to the supply chain. As such, example embodiments of the present invention may provide for defining intelligent data groupings based on supply chain model similarities. In this regard, for example, mathematical modeling tools may be employed to rate supply chain characteristics for corresponding products. Products having supply chain characteristics that are rated similarly to one another (e.g., based on a scoring algorithm or other criteria) may be rolled up together so that data associated with such products is aggregated prior to running an optimization algorithm with respect to the corresponding data. As an example, if 100 products are analyzed in a particular supply chain and those products break up into 15 groups of products having similar supply chain characteristics, data aggregation may be performed for clean data grouped within the corresponding 15 groups. Accordingly, the optimization module 66 of an example embodiment may perform optimization based on supply chain similarities relative to a particular business question at issue (e.g., supply chain concerns), rather than based upon groupings set by marketing or sales concerns that may not respect supply chain differences.

Following data grouping, a baseline may be established along with scenarios of interest at operation 260. Thereafter, at operation 270 stress tests may be conducted and optimization results may be finalized using an optimization tool. In some cases, any commercially available optimization tool may be employed. The intelligent grouping of data, coupled with the fact that cleansed data is being used, may enable even a commercially available optimization tool to perform better than would otherwise be the case with other data groupings and/or the use of data that is not cleansed as described herein.

In some embodiments, after using the optimization module 66 to generate optimization results, the optimization may be granularized in connection with finalizing the results. In this regard, for example, since the logic for rolling up or grouping data is known, it may be possible to decouple the aggregation to back track to more granular views of optimization results.

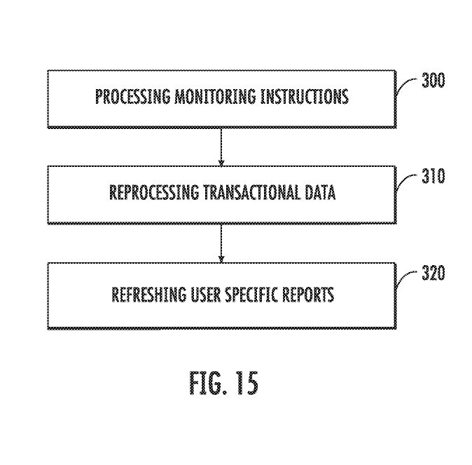

In examples where performance monitoring is performed, the monitoring module 68 may be configured to perform some or all of the example operations shown in FIG. 15. In this regard, for example, the monitoring module 68 may be configured to process monitoring instructions at operation 300. The monitoring instructions may include, for example, operator defined instructions to establish a monitoring cycle, identify reports requested by the operator, identify targets (e.g., performance targets), and/or identify alert instructions corresponding to respective targets being met or exceeded to selected areas of interest like specific areas of net landed cost to serve or in product, inventory, channel, customer, transportation, sales or profit performance. This also is a benefit in synchronizing the management activities from the executive level to the operational level since the same common source of data is used for all levels of reporting. In some embodiments, the monitoring module 68 may further enable reprocessing of transactional data at operation 310. The reprocessing may be undertaken subsequent to cyclic gathering of new transactional data and processing the data using the rule sets established during profiling. Thereafter, the monitoring module 68 may be further configured to refresh user specific reports at operation 320.

In an example embodiment, the monitoring cycle may define the data gathering and/or report generation periodicity associated with performance monitoring operations. For example, daily, weekly, bi-weekly, monthly, quarterly, annually, or bi-annually updated data sets may be specified by the operator. When the defined periodicity is reached, transactional data may be acquired in its native format and converted as described above into enhanced data. The originally extracted data may be used as baseline data for comparison purposes when a new cycle is to be performed. However, in some cases, the baseline data may be the immediately prior data, an average of two or more previously acquired data sets, or any other selection or grouping of data sets previously gathered.

Processing of monitoring instructions may further include the utilization and/or establishment of reports, which may be generated at the same monitoring frequency, or may be generated based on data gathered at the defined monitoring frequency using data gathered in the most recent cycle or any combination of previously executed cycles. In some embodiments, the storage device 54 may store instructions associated with the monitoring module 68 to define available functionality that may be practiced on a given data set. Thus, for example, data associated with a specific organization may be stored in a segregated fashion, separately and securely with respect to any data associated with other organizations (e.g., in the database server 42 dedicated to the specific organization or in a portion of the database server 42 that is dedicated to the specific organization). However, many reporting and processing functions that may be performed with respect to the data may be available to any organization. Thus, the monitoring module 68 may be configured to provide functionalities (e.g., via storing instructions for execution of those functionalities in the storage device 54 for execution by the processor 50) that are common across different organizations, but the functionalities may only be practiced on data that is specific to a corresponding organization. Moreover, in some cases, functionalities may actually be limited by selection of the corresponding organization based on the permission or access levels granted to users within that corresponding organization. In some embodiments, certain users (e.g., power users) may be enabled to modify reporting templates or generate their own reporting templates (e.g., on the fly). Power users may utilize tools associated with the monitoring module 68 that are only exposed to certain licensed users that have requested such functionality. In some embodiments, commercially available report generation tools may be used to generate request templates, however, those tools may only be enabled responsive to permissions being granted for the use of such tools by host network 32 operators.

In some embodiments, the user may be further enabled to identify target or threshold values for various parameters that may be displayed on at least some of the reports. The target or threshold values may be enabled to be displayed in tabular format, or on generated charts. Furthermore, in some embodiments, the user may be enabled to define alerts to be issued when certain target or threshold values are reached. In some cases, the alerts may be provided within the context of the website of the organization (e.g., a flag, red light, flashing light, or other noticeable icon, image or visual effect displayed on the dashboard or elsewhere). However, in other cases, the alerts may be provided outside of the context of the website of the organization. For example, email alerts, text messages, multimedia messages, or other remote notifications may be provided to specific organizational personnel or in the form of reports that contain relevant information concerning the triggering of the alert. In some embodiments, the user may define the mechanism by which the alerts are to be provided responsive to various thresholds being met. Moreover, in some cases, the user may define escalating alerting protocols via which increasingly more prominent alerting techniques are employed as increasingly higher (or lower) threshold levels are crossed.

In an example embodiment, there may be a library of report templates provided to users in a selectable format. The users may view and select report templates that are of interest to study, print, export, or otherwise utilize. In some embodiments, the service application 44 may host a website that is tailored to each respective organization (or to specific entities or permission levels within the organization). The website may be accessible via the Internet by secure login. After the website is accessed, various options for interacting with data may be presented. For example, the operator may be enabled to select options from a menu, or icons from a list of icons, which are related to profiling, optimization or monitoring activities. The options may also include an option to create or view a supply chain management dashboard.

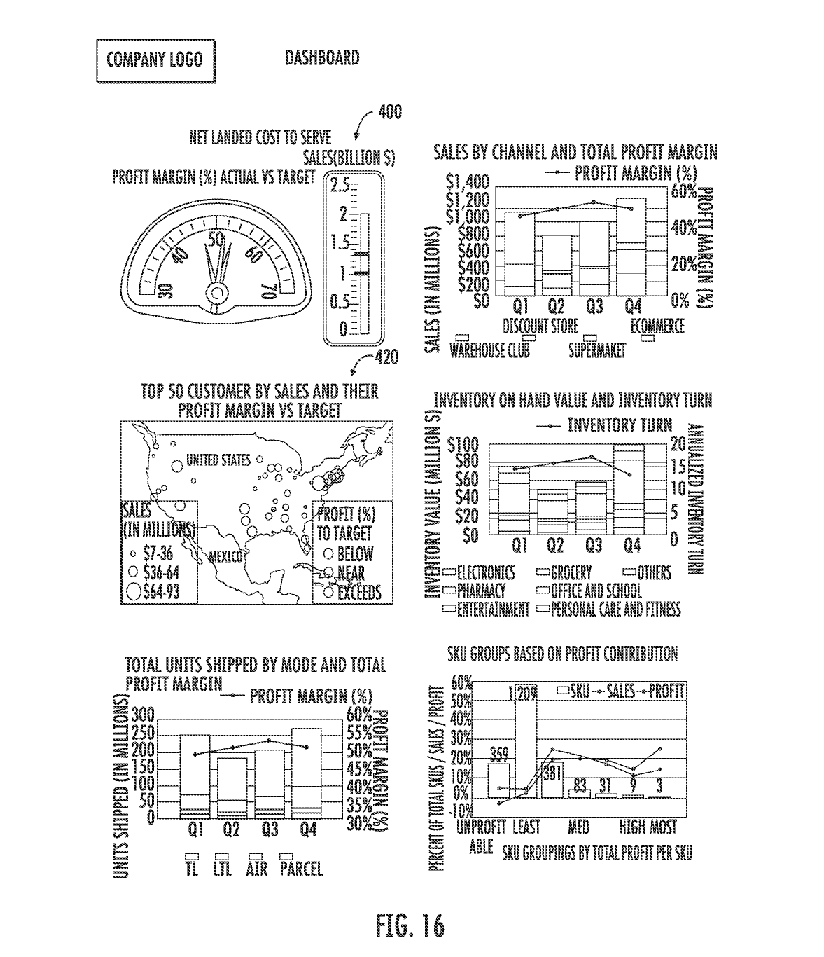

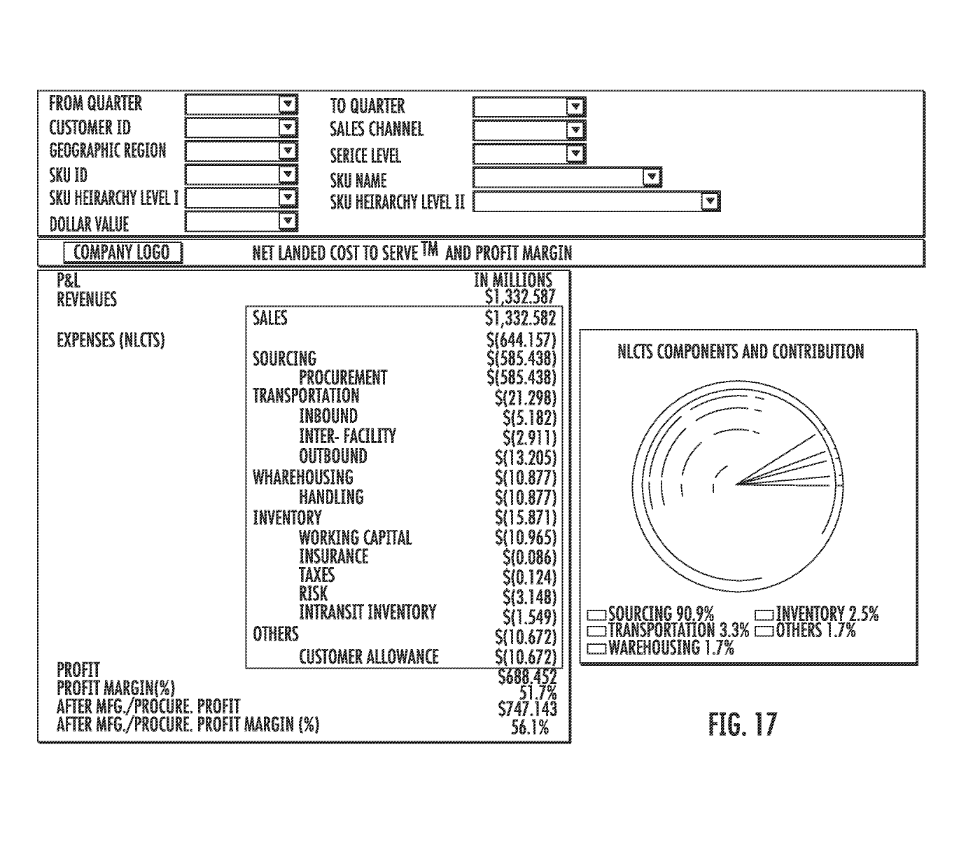

FIG. 16 illustrates an example screenshot of a supply chain management dashboard that may be presented according to an example embodiment. In some embodiments, the dashboard may be fixed by organization to show charts, graphs or other reporting formats that have been selected by executives or other organizational personnel to be presented for given permission levels within the organization. However, in other cases, each user (or users with special permission) may be enabled to adjust the organization and/or content of the dashboard. Moreover, in an example embodiment, a dashboard construction wizard or application may be provided to enable users to tailor the dashboard in any desirable fashion such as by presenting all available reports or reporting formats in menu form and enabling the user to select desirable reports/formats for presentation at selected locations on a tailored dashboard. As such, the dashboard may include any number of reporting charts, graphs or other reporting formats that the user may desire to have presented on a given screen.

In an example embodiment, at least some of the charts, graphs or reports presented on the dashboard may be selectable. For example, on the dashboard of FIG. 16, one of the displayed charts may relate to the net landed cost to serve (NLCTS). NLCTS may represent, for an SKU from the transactional layer, every element of cost aggregated over the entire end to end transition represented in the supply chain. As such, the NLCTS may represent an accurate and direct cost for an SKU based on transactional layer data. The NLCTS chart 400 may be selectable. Responsive to selection of the NLCTS chart 400, more detailed reports related to NLCTS may be accessible. As such, by selection of charts on the dashboard, a drill down capability may be presented to the user in order to enable the user to access more detailed information regarding a corresponding chart. In this regard, FIG. 17 illustrates an example drill down report for NLCTS. As can be seen in FIG. 17, the user may be enabled to select specific time periods, geographic limitations, movement channels, service levels, SKUs (by SKU ID or name), customer delivery location, combinations of the above elections and/or the like.

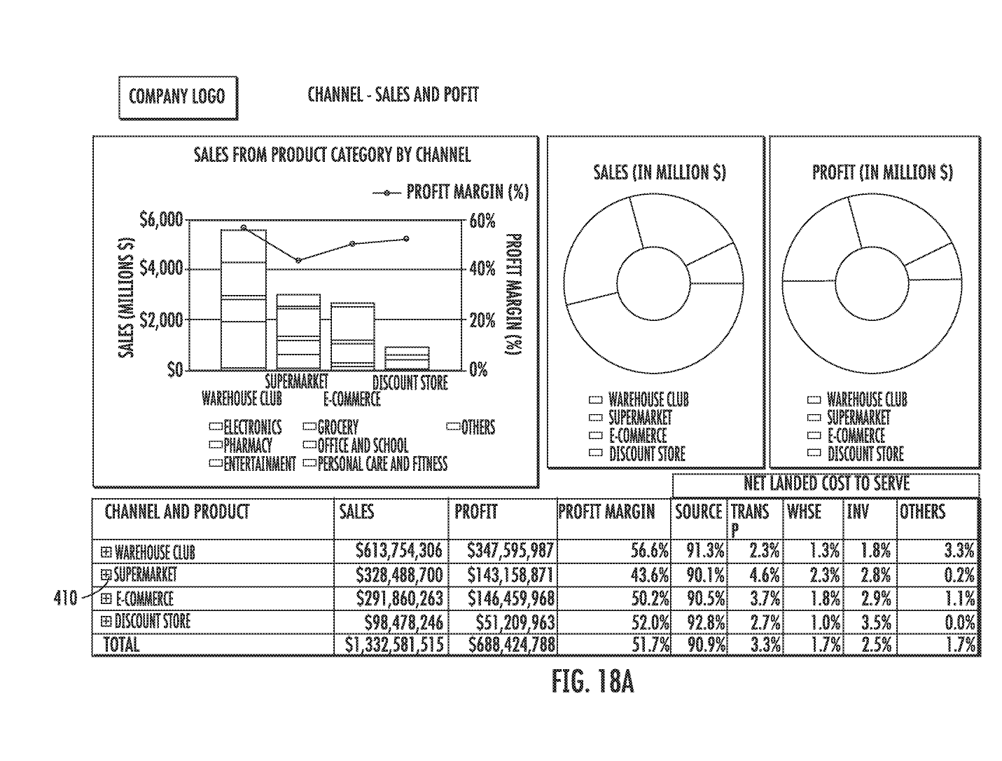

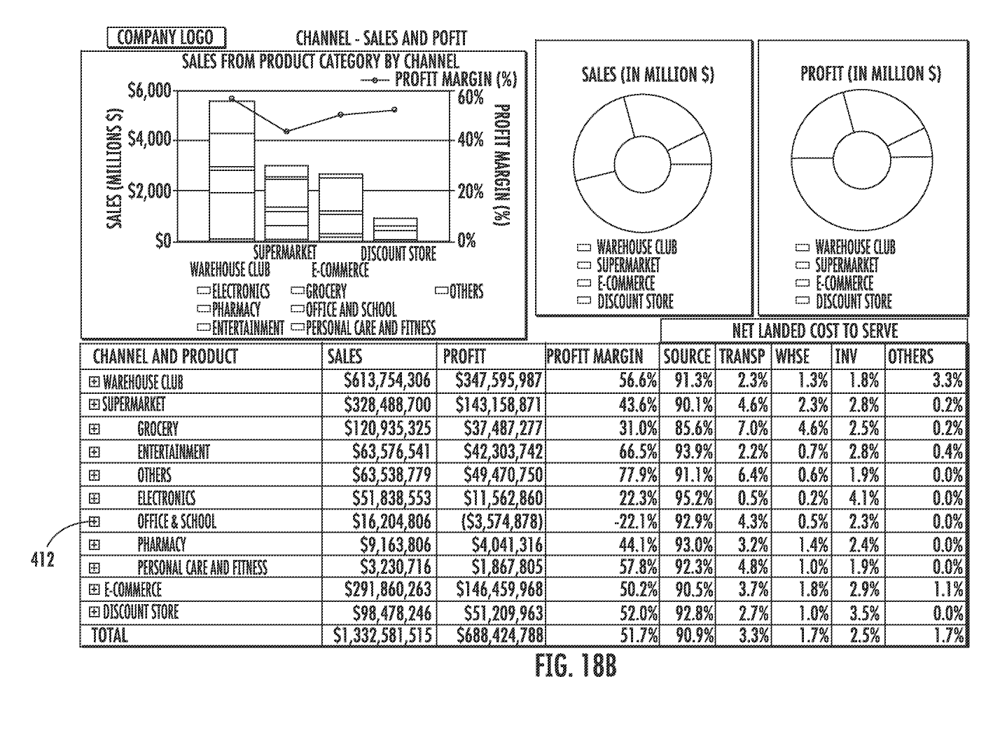

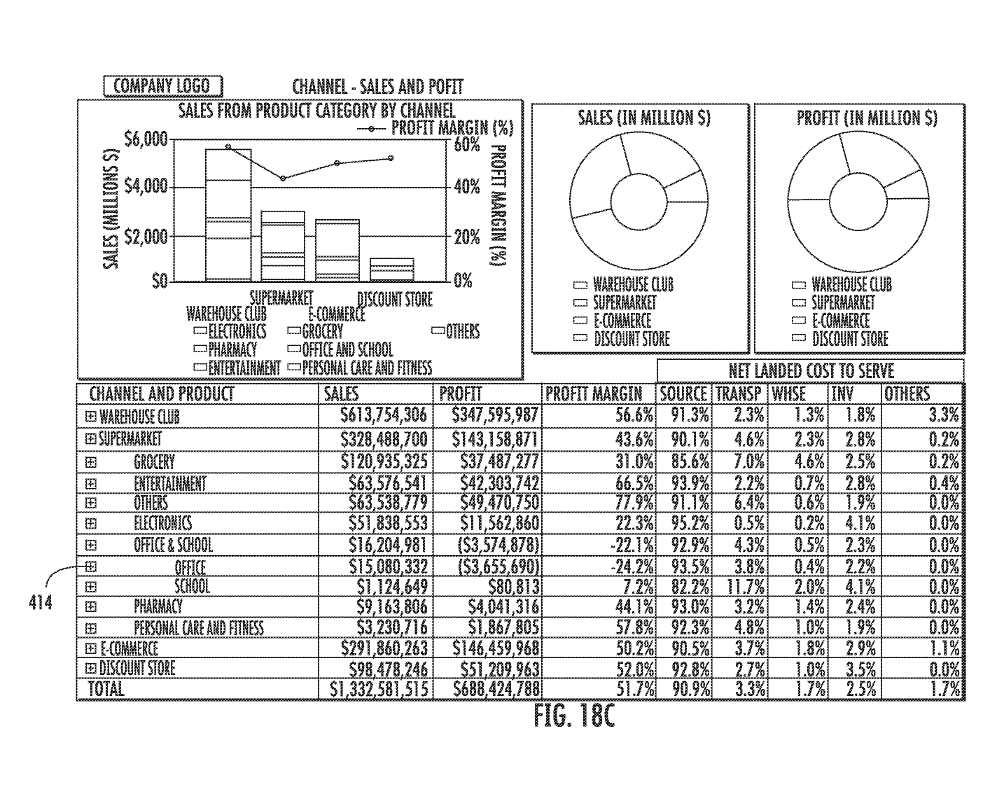

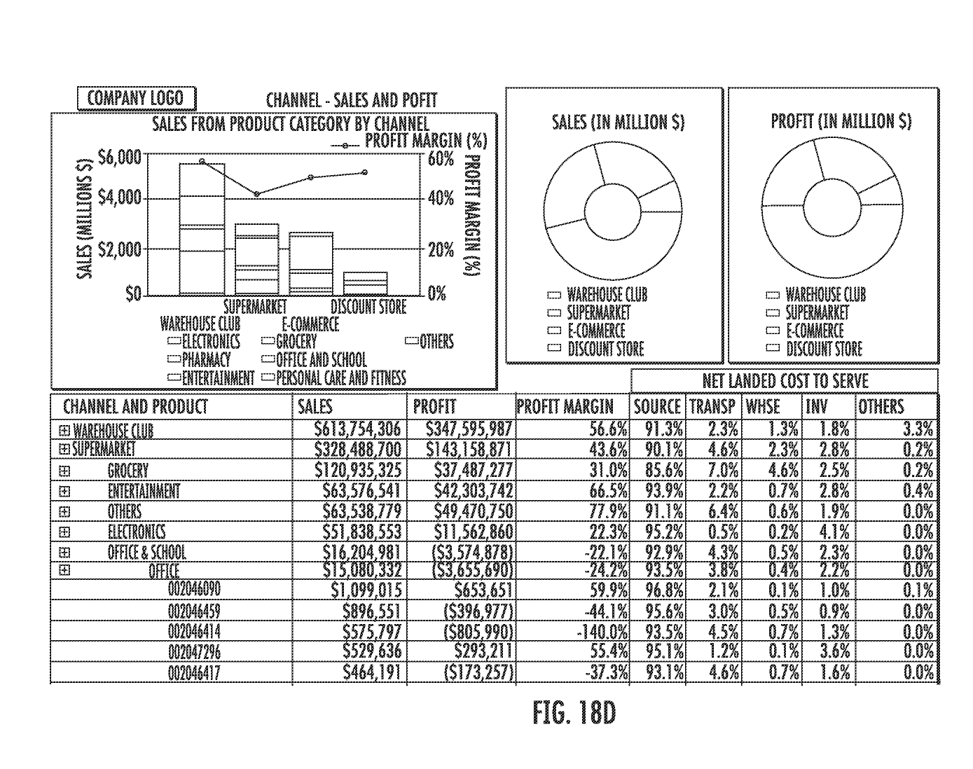

FIG. 18, which includes FIGS. 18A, 18B, 18C and 18D, illustrates various levels of drill down capability all the way to the SKU level according to an example embodiment. In this regard, FIG. 18A illustrates the sales and profit from a product category by channel. As shown in FIG. 18A, the report may include bar charts, pie charts and NLCTS information that can be drilled down into for improved granularity. For example, if the supermarket channel 410 is selected on FIG. 18A, data associated with more detailed categories at a lower level may then be presented as shown in FIG. 18B. In response to selection of a more detailed category (e.g., the office & school category 412), more detailed categories at a next lower level may be presented as shown in FIG. 18C. Finally, by selecting the category level immediately above the SKU level (e.g., the office category 414 in FIG. 18C), data associated with all SKUs that are associated with the specific channel selected may be presented as shown in FIG. 18D.

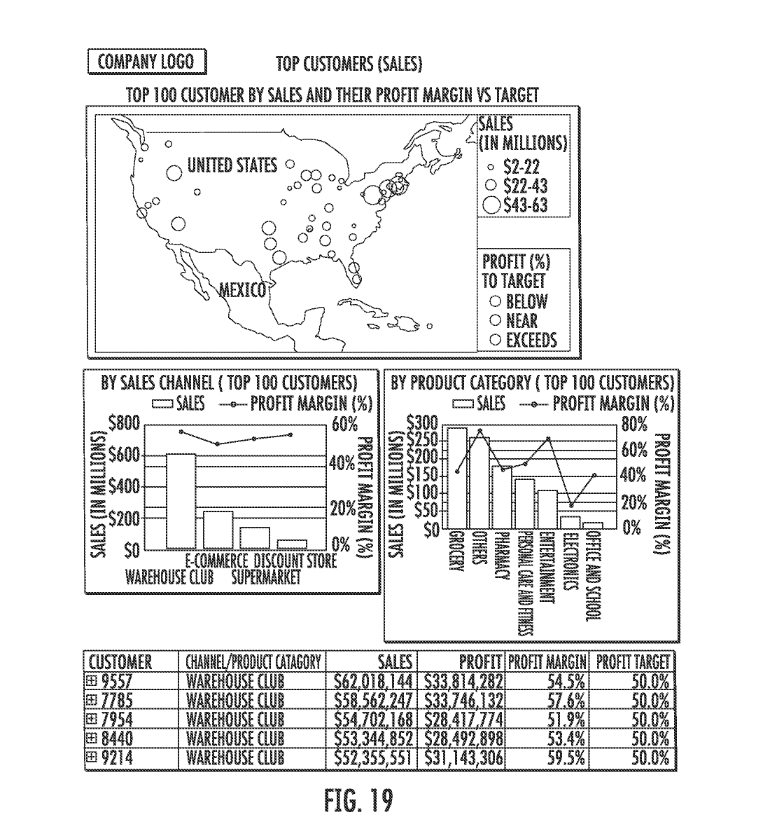

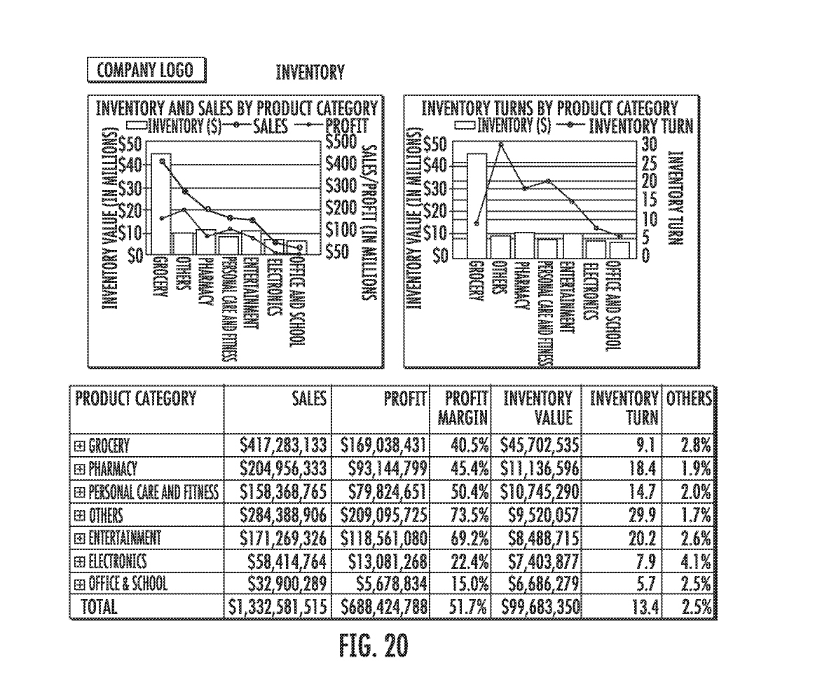

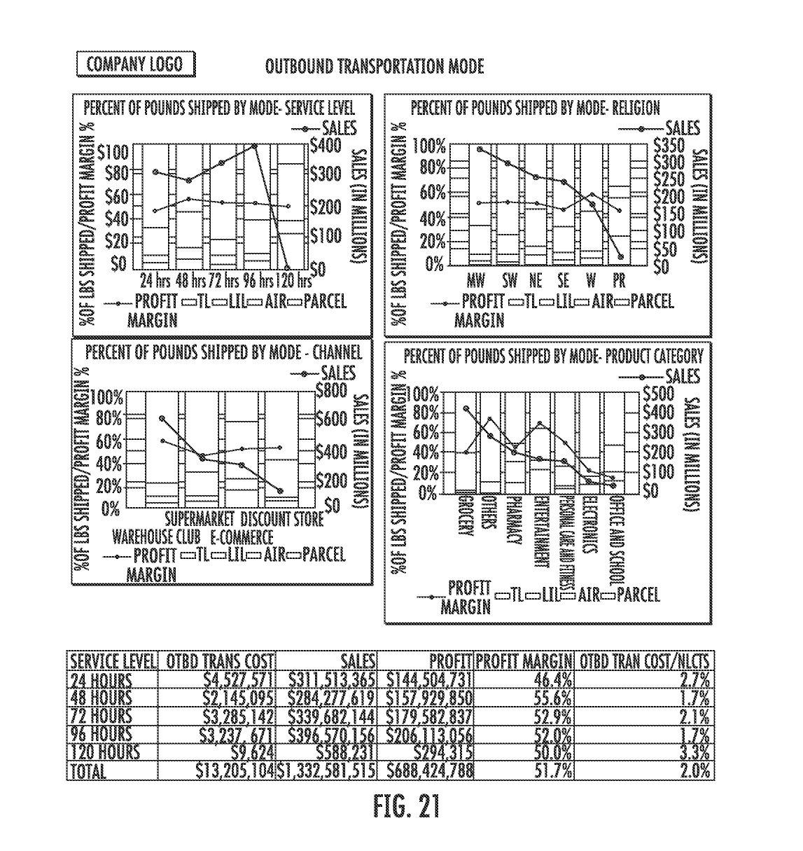

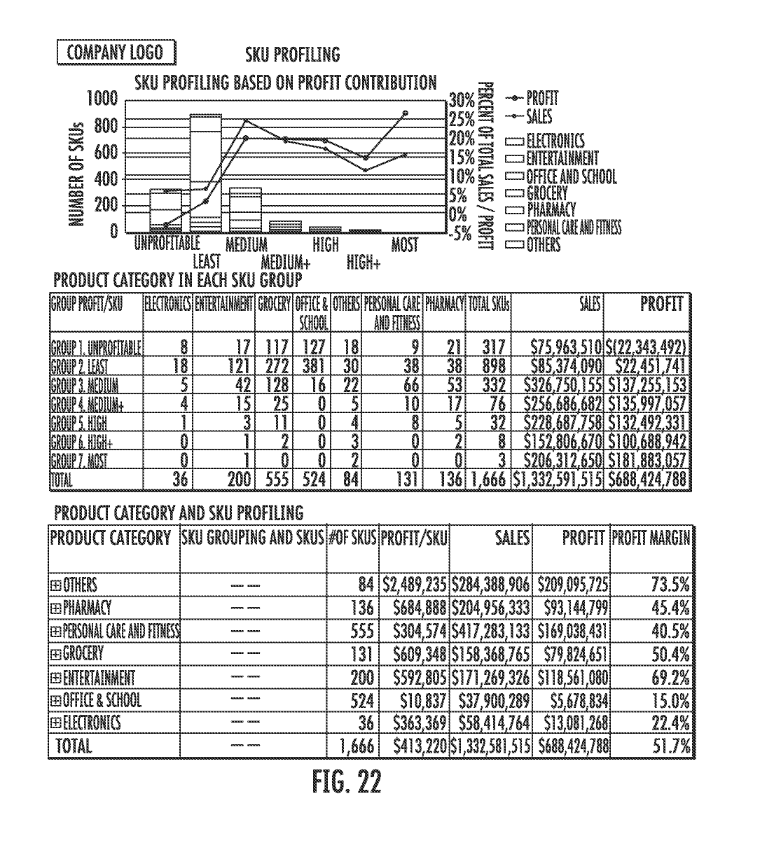

FIG. 19 illustrates a report page presented responsive to selection of the top customer chart 420 from the dashboard of FIG. 16. FIG. 20 illustrates a report page showing inventory related charts. Sales, profit, profit margin, inventory value, inventory turn, and a ratio of inventory carrying cost to NLCTS may be presented in tabular form with drill down capability for various product categories. FIG. 21 illustrates reports associated with outbound transportation mode. FIG. 22 illustrates a report associated with SKU profiling based on profit contribution according to an example embodiment. Many other reports and formats may also be presented in association with the practicing of example embodiments. Thus, the monitoring module 68 may be configured to provide a great deal of flexibility to users with respect to reporting capabilities. Moreover, new report formats may be imported and created (e.g., by power users or by host device 40 operators) at any time and made available for users to generate and/or retrieve. Some reports may be generated at the time of request using report generation tools that operate on data specific to the organization associated with the request. However, other reports may be previously generated and may be stored in association with the organization so that the report may be retrieved upon request. In all cases, however, the data operated on is specific to the organization (and is generated based on the companies own transactional data in its native format into processed, cleansed and enhanced data), but the tools used to generate the reports are not necessarily specific to the organization.

In some embodiments, the profiling, optimization and monitoring that may be performed by the host device 40 (or the processing circuitry 50 thereof) may be performed in a descriptive fashion (e.g., looking backward at historical data). However, in some example embodiments, the host device 40 and/or service application 44 may include predictive capabilities. In this regard, for example, in some embodiments, the processor 52 (or the processing circuitry 50) may be embodied as, include or otherwise control a predictive module 70 (shown in dashed lines in FIG. 2). If employed, the predictive module 70 may be configured to use statistical data (either from past cycles for a particular organization or from other organizations in a similar field) to predict future operating performance may be presented in the report formats otherwise capable of being presented by example embodiments. Moreover, in some cases, the predictive module 70 may be enabled to predict trends and illustrate predictive responses to various proposed stimuli. Thus, for example, the projected impact of shifting of suppliers, changing transportation routes or modes, and other changes for which the impact of projected changes or forecasts can be analyzed using predictive techniques. In a similar fashion, the predictive module 70 may be enabled to simulate future operating performance and illustrate simulated responses to various proposed stimuli.

As indicated above, in some instances, data associated with organizations in a similar field may be used for statistical analysis. In some embodiments, contribution of organizational data for use in such a pool may be voluntary on the part of the organizations (e.g., an opt in data pooling arrangement). The identity of pool members and the specific details of the data may be kept confidential and may not be communicated to other pool members in some cases. In such an example, each organization may be enabled to benchmark their data against the pool (e.g., against the average corresponding data or metrics of the pool members) or a specific pool made up of organizations that have similar characteristics with their operations. Thus, for example, benchmarking may be provided for any portion of the entire end to end supply chain of similar companies. The benchmarking may be provided in connection with report generation such that reports generated for the organization may be compared to corresponding reports for anonymous pool members or average data associated with anonymous pool members.

In some embodiments, the processing circuitry 50 may be further configured to perform risk analysis functions. In this regard, for example, the profiling module 64 may be configured to analyze aspects of the visual representation of the supply chain (or the data used to generate the visual representation) to identify or quantify risk associated with aspects thereof. Situations such as single supplier sourcing or situations where one supplier provides a very large percentage of supply in a particular area may be identified as high risk situations. Furthermore, statistical failure or incident rates (e.g., industry wide or based on specific supplier performance) may also be accounted for in risk assessment for specific portions of the supply chain. In some cases, alerts may be provided relative to risk determinations. Alternatively or additionally, risk related assessment information may be provided on the visual representation (or responsive to selection of links associated with specific portions of the visual representation). In some embodiments, the predictive module 70 may be configured to project impacts of certain failures or incidents indicated as being risks. In these situations, the predictive module 70 may be configured to employ statistical analysis of known impacts from past events to predict the impact of a future occurrence of a similar event on a known supply chain or simulate the impact on operational performance.

Example embodiments may therefore provide a robust capability to expose users to supply chain performance management data on an end to end basis (raw material to final consumption of a finished good product). Moreover, the exposure may be easily navigable between different levels of granularity including all the way down to the SKU level and/or customer delivery location. Furthermore, example embodiments may utilize transactional level data in its native format and covert and then cleanse the data to generate data that is correlated throughout an entire organization and universally accepted within that organization to accurately reflect the supply chain of the organization. This enhanced data may then be accessed as needed to generate reports that enable performance management. After the supply chain of the organization is profiled, optimization and/or monitoring activities may be conducted and/or repeatedly conducted at desirable intervals in order to maximize the ongoing benefit to the organization. The fact that these embodiments provide for a single and organizationally accepted set of data to be used cross functionally within the organization (e.g., by individuals associated with sales, marketing, operations, supply chain, finance, etc.) means that the entire organization has access to “one version of the truth” that is commonly accepted within the organization. Report generation and utility of the monitoring aspects and visual representations generated according to example embodiments may therefore take the performance management capability for supply chain operations and other cross functional operations to performance levels that has not previously been achievable.

Embodiments of the present invention may therefore be practiced using an apparatus such as the one depicted in FIG. 2. However, other embodiments may be practiced in connection with a computer program product for performing embodiments of the present invention. As such, for example, each block or step of the flowcharts of FIGS. 3, 14, 15 and 23, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s). In this regard, a method according to example embodiments of the invention may include any or all of the operations shown in FIGS. 3, 14, 15 and 23. Moreover, other methods derived from the descriptions provided herein may also be performed responsive to execution of steps associated with such methods by a computer programmed to be transformed into a machine specifically configured to perform such methods.

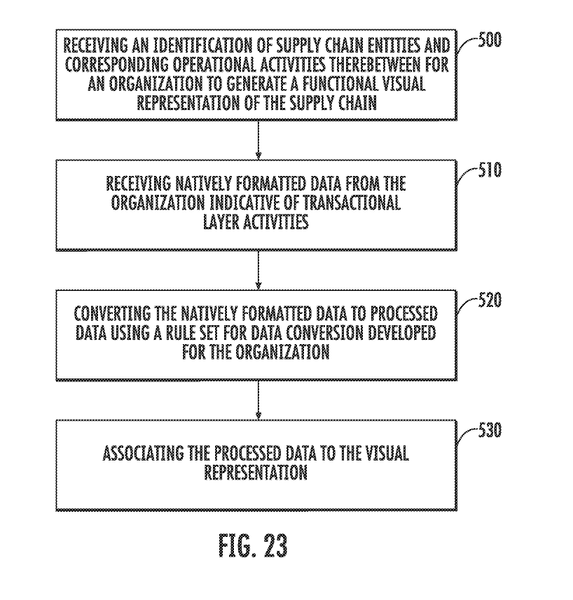

In an example embodiment, a method for providing a supply chain performance management tool, as shown in FIG. 23, may include receiving an identification of supply chain entities and corresponding operational activities therebetween for an organization to generate a functional visual representation of the supply chain at operation 500 and receiving natively formatted data from the organization indicative of transactional layer activities (e.g., activities related to supply chain, sales, operations, marketing and other functional transactions) of the organization's operation 510. The method may further include converting (e.g., via processing circuitry) the natively formatted data to processed data using a rule set for data conversion developed for the organization at operation 520 and associating the processed data to the visual representation at operation 530. In some cases, the association may include linking the data to portions of the visual representation so that the data can be accessed by selection of links presented in the visual representation.

In an example embodiment, an apparatus for performing the method of FIG. 23 above may comprise a processor (e.g., the processor 52) configured to perform some or each of the operations (500-530) described above. The processor 52 may, for example, be configured to perform the operations (500-530) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-530 may comprise, for example, the profiling module 64. Additionally or alternatively, at least by virtue of the fact that the processor 52 may be configured to control or even be embodied as the profiling module 64, the processor 52 and/or a device or circuitry for executing instructions or executing an algorithm for processing information as described above may also form example means for performing operations 500-530.

In some embodiments, a method for providing a supply chain performance management tool implementable by processing circuitry may include generating a representation of a supply chain of an organization where the representation is generated responsive to identification of supply chain entities and corresponding flows therebetween. The flows may include transactional layer activities at a stock keeping unit level. The method may further include referencing the representation to define data groupings based on supply chain similarities, establishing baseline data and at least one scenario, and employing the defined data groupings to run a test relative to the at least one scenario, via processing circuitry, to generate performance results relative to the baseline data (e.g., in terms of dimensions of cost, profit and risk).

The method may be augmented or modified in some cases, as described below. In this regard, for example, the method may further include generating alerts based on proximity of data of the performance results to predefined thresholds. Generating the alerts may include generating the alerts based on a predefined escalating alert protocol. In some cases, defining the data groupings based on supply chain similarities may include aggregating transactional layer activities that have been normalized and are associated with similar supply chain activities to reduce data set size. In some embodiments, such a method may further include enabling a user to decouple aggregation to provide granular level of detail views of the performance results. In an example embodiment, aggregating transactional layer activities may include rating supply chain characteristics using a scoring algorithm and aggregating data of supply chain flows having similar rated supply chain characteristics. In some embodiments, establishing baseline data comprises utilizing originally extracted data, data from an immediately prior cycle, or an average of data from prior cycles as the baseline data. In some cases, employing the defined data groupings to run the test may include gathering a new cycle of data at a predefined periodicity and generating performance results by comparing the new cycle of data to the baseline data. In an example embodiment, the representation may be generated by converting natively formatted data to processed data via a rule set employing data linkage keys that associate data used in a first context by one entity of the supply chain to data used in a second context by another entity and employing the rule set to correlate data between entities prior to conversion into the processed data. In some cases, establishing baseline data may include utilizing data associated with one or more members of a pool of similar organizations as the baseline, and running the test may include comparing data of the defined data groupings to the data associated with the one or more members of the pool to benchmark the organization against the one or more members of the pool. In such an example, the one or more members of the pool may opt in to become members of the pool, and an identity of pool members may be confidential.

Example embodiments may therefore provide one source of data that has been validated and that may cover the entire span of the supply chain functions and all constituent parts thereof. This single data source can be built using contributions from a plurality of systems spanning from end to end of the supply chain and may, in some cases, include multiple companies that are directly or indirectly involved in the supply chain since some supply chains from raw material to the final distribution of finished goods may be run by multiple companies. For example, suppliers, service providers, manufacturers, distribution centers, third parties, distributors, end customers and the corresponding systems that manage the transactions in which the above listed parties engage (e.g., tactical supply planning systems, product management systems, order management systems, manufacturing execution systems, enterprise resource planning (ERP) systems, warehouse management systems, demand planning systems, transportation planning systems, price management systems and other systems) may all provide data regarding actual transactional activities. Functional analytics of example embodiments may then be employed so that the functions performing various processes that are captured by the transactional activities over many systems can be analyzed in order to supply answers to questions (e.g., descriptive, predictive and/or prescriptive) on costs, profits or risks associated with the supply chain or other business related questions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing reports associated with improving supply chain performance comprising:
generating a representation of a supply chain of an organization, the representation being generated responsive to identification of supply chain entities and corresponding flows therebetween, the flows including transactional layer activities at a stock keeping unit level;
referencing the representation to define data groupings based on supply chain similarities;
establishing baseline data and at least one scenario; and
employing the defined data groupings to run a test relative to the at least one scenario, via processing circuitry, to generate performance results relative to the baseline data.

2. The method of claim 1, wherein defining the data groupings based on supply chain similarities comprises aggregating transactional layer activities that have been normalized and are associated with similar supply chain activities to reduce data set size.

3. The method of claim 2, wherein aggregating transactional layer activities comprises rating supply chain characteristics using a scoring algorithm and aggregating data of supply chain flows having similar rated supply chain characteristics.

4. The method of claim 2, further comprising enabling a user to decouple aggregation to provide granular level of detail views of the performance results.

5. The method of claim 1, wherein establishing baseline data comprises utilizing originally extracted data as the baseline data.

6. The method of claim 1, wherein establishing baseline data comprises utilizing data from an immediately prior cycle as the baseline data.

7. The method of claim 1, wherein establishing baseline data comprises utilizing an average of data from prior cycles as the baseline data.

8. The method of claim 1, wherein employing the defined data groupings to run the test comprises gathering a new cycle of data at a predefined periodicity and generating performance results by comparing the new cycle of data to the baseline data.

9. The method of claim 1, wherein the representation is generated by converting natively formatted data to processed data via a rule set employing data linkage keys that associate data used in a first context by one entity of the supply chain to data used in a second context by another entity and employing the rule set to correlate data between entities prior to conversion into the processed data.

10. The method of claim 1, further comprising generating alerts based on proximity of data of the performance results to predefined thresholds.

11. The method of claim 10, wherein generating alerts comprises generating the alerts based on a predefined escalating alert protocol.

12. The method of claim 1, wherein establishing baseline data comprises utilizing data associated with one or more members of a pool of similar organizations as the baseline, and wherein running the test comprises comparing data of the defined data groupings to the data associated with the one or more members of the pool to benchmark the organization against the one or more members of the pool.

13. The method of claim 12, wherein the one or more members of the pool opt in to become members of the pool, and wherein an identity of pool members is confidential.

14. A computer program product for providing reports associated with improving supply chain performance, the computer program product comprising at least one computer-readable storage medium having computer-executable program code instructions stored therein, the computer-executable program code instructions comprising program code instructions for:
generating a representation of a supply chain of an organization, the representation being generated responsive to identification of supply chain entities and corresponding flows therebetween, the flows including transactional layer activities at a stock keeping unit level;
referencing the representation to define data groupings based on supply chain similarities;
establishing baseline data and at least one scenario; and
employing the defined data groupings to run a test relative to the at least one scenario, via processing circuitry, to generate performance results relative to the baseline data.

15. The computer program product of claim 14, wherein program code instructions for defining the data groupings based on supply chain similarities include instructions for aggregating transactional layer activities that have been normalized and are associated with similar supply chain activities to reduce data set size.

16. The computer program product of claim 15, wherein program code instructions for aggregating transactional layer activities include instructions for rating supply chain characteristics using a scoring algorithm and aggregating data of supply chain flows having similar rated supply chain characteristics.

17. The computer program product of claim 15, further comprising program code instructions for enabling a user to decouple aggregation to provide granular level of detail views of the performance results.

18. The computer program product of claim 14, wherein program code instructions for establishing baseline data include instructions for utilizing originally extracted data as the baseline data or for utilizing data from an immediately prior cycle as the baseline data.

19. The computer program product of claim 14, wherein program code instructions for establishing baseline data include instructions for utilizing an average of data from prior cycles as the baseline data.

20. The computer program product of claim 14, wherein program code instructions for employing the defined data groupings to run the test include instructions for gathering a new cycle of data at a predefined periodicity and generating performance results by comparing the new cycle of data to the baseline data.
